(19) United States
(12) Patent Application Publication
(10) Pub. No.: US 2004/0068346 A1
(43) Pub. Date: Apr. 8, 2004

(54) System for distributing articles

(76) Inventor: Michel Boucher, Rimouski (CA)

Correspondence Address: Robert Brouillette, BROUILLETTE KOSIE PRINCE, 25th Floor, 1100 Rene-Levesque Boulevard West, Montreal, QC, H3B 5C9, CA

(21) Appl. No.: 10/608,501

(22) Filed: Jun. 30, 2003

(30) Foreign Application Priority Data
Jun. 28, 2002 (CA) 2,391,599

(51) Int. Cl. G06F 17/00

(52) U.S. Cl. 700/241; 700/236; 700/237

(57) ABSTRACT

A computerized management system which is administrated with the use of a computer network linked by modem or other communication means, comprising a server and its database, administration and communication software; vending machines equipped with computer systems allowing for remote inventory management and methods to put products on the market which are offered via a vending machine including medical or other supplies.

### FIELD OF THE INVENTION

A computerized system allowing the remote operation and inventory management of a vending machine for the distribution of products, such as medical material supplies

### BACKGROUND OF THE INVENTION

On top of medical care given in hospitals or in clinics, patients require a large quantity of medical supplies during their treatments. These supplies, such as bandages, crotches, certain everyday drugs and many other article related to surgical procedures, require the use of a strict and controlled inventory management system in order to prevent abuses and/or unnecessary expenses. Fitzgerald (U.S. Pat. No. 5,638,985) and Shoenfeld (U.S. Pat. No. 6,223,934) propose systems using vending machines allowing the automatic control of the items provided to the users, but the inventory management is always done on the site where the vending machine is located.

The advent of computers has made it possible to offer a permanent control of the inventory management in the sales process involving vending machines with the use of centralized signals sent to persons responsible for the proper operation of the vending machines. Based on this, McGrady et al. (U.S. Pat. No. 5,848,593 et U.S. Pat. No. 5,912,818) developed a vending machine linked to a local network allowing the control of the products given to the users by using a database. Those inventions have permitted a better management control of the medical inventory and have offered the possibility to do the follow-up of the patients with respect to their treatments with the help of different terminals connected to the network.

However, the management of such vending machines requires an inventory management system which is flexible with regards to the time of the day, to the locations and to its different users, on top of allowing a bi-directional communication between an administrator and a vending machine in an interactive manner.

The present invention introduces a management system for vending machines allowing the system administrators at any time of the day to automatically and remotely manage all the functionalities of vending machines integrated in the network, with the help of a software installed in the computer terminals of the administrators and in the vending machines in the network.

When a communication software is used, the present invention also allows smart communications which permit the transmittal of messages between the vending machines and the computer terminals destined to the different participants in the management, use and maintenance of such vending machines.

### SUMMARY OF THE INVENTION

This invention comprises many inventive contributions in the vending machine field with the integration of networking concepts, of interactive operating modes and of inventory management, all that being achieved with the help of a micro-controller which is integrated to the computer system of the vending machines, and of management and communication software which are accessible to the users and to the administrators via a remotely operatable network.

Indeed, this management system offers a remote ejection device which allows the user to obtain another product without having to go through the banking system or to obtain another product in the case where the product is stuck or defective. The company that owns the vending machines can also sell products to the hospital, for its own internal needs, by remotely releasing the ordered products and billing the hospital later on.

The remote retrieval of a sales data allows to the administrator of the vending machines to recuperate his/her sales data at the frequency and the time of his/her choice in a useful, secure and quick way, without having to move, thanks to the use of the communication system and of the software which are part of the present invention.

The software which is installed on each vending machine's computer system, which is part of the present invention, preferably comprises a filling sub-system to be used with a bar code reading pen. This device enables a faster filling with one stroke of the pen. Previously, the code of each compartment had to be entered one by one. The pen also serves to identify the products in virtual compartments which allow for supplementary sales.

It is also possible to use remote initialization means for a vending machine which allows the set up of the data system relative to the inventory of a new vending machine. The management system also makes it possible to change this inventory at any time, whether for one product or for the entire content of the vending machine and that, without wasting a lot of time by having to recompile data in the network's database.

Remote compartment modification means are also a functionality associated to the system's management mode which offers the possibility to remotely change the compartment's configuration of the vending machine, according to the specifications of a product to be offered in the future. The system's networked database may be remotely modified and the confirmation of this modification will only go through when the technician will open the vending machine to perform a filling.

When the products to offer via a vending machine necessitate too much space, the use of the virtual compartment feature makes it possible to offer to the users the possibility to select merchandises physically located outside of the vending machine with the help of the corresponding bar code, then to pay the price using the “payment module” of the vending machine. This functionality also offers the opportunity to offer more products to the vending machine's users when the merchandise control becomes necessary for security reasons or because of the product's value.

The communication sub-system of the vending machine with the central server is unique and at the heart of the management system of this invention, because it makes it possible to know which vending machine fail(s) to meet the previously established condition for an acceptable inventory. Since each vending machine sends a message to the central system, this information becomes available to every technician and administrator of the network when it reaches a “critic mass” per compartment.

One of the applications installed on the computer system of the vending machine allows the users to have direct access, through a modem or other known means, to a banking system via a debit card, or to pay with a credit card or with cash, and also to offer the possibility to buy a plurality of products during the same transaction.

### BRIEF DESCRIPTION OF THE FIGURES

FIG. 1 shows a front view of a vending machine incorporating the invention.

FIG. 2 schematically illustrate the links between the different components of a network according to the invention.

FIG. 3 shows a partial view of a computer system installed inside the vending machine shown in FIG. 1.

FIG. 4 shows an interface of the management software for the remote management options, as seen from the computer terminal.

FIG. 5 shows an interface of the management software to connect to the server, as seen from the computer terminal.

FIG. 6 shows an interface of the management software to modify the vending machines' configurations, as seen from the computer terminal.

FIG. 7 shows an interface of the communication software as seen from the computer terminal.

FIG. 8 shows an interface of the communication software as seen from the vending machine's screen.

FIG. 9 shows a schematic view of a portion of the vending machine's computer system.

### DETAILED DESCRIPTION OF A PREFERRED EMBODIMENT

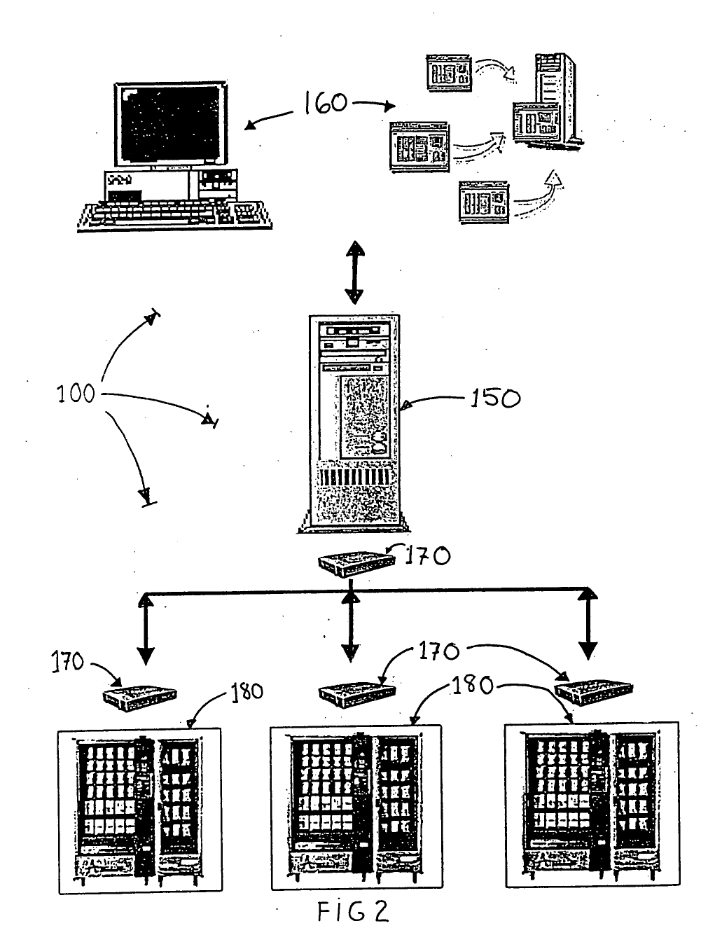

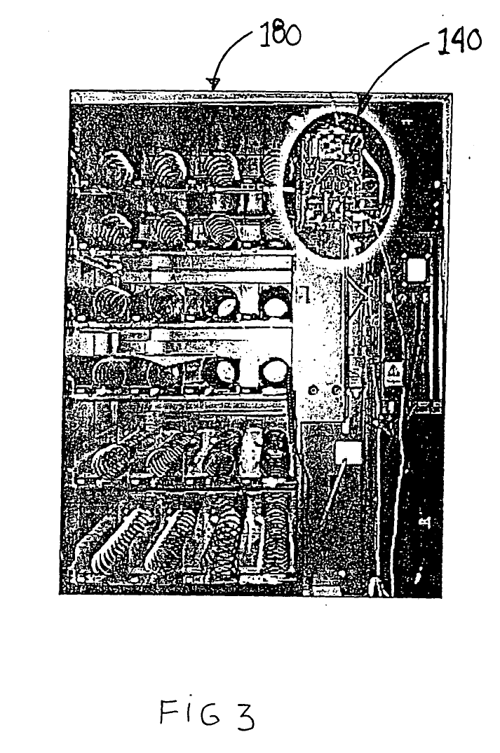

The system presented in this invention and schematically shown in FIG. 2 comprises a computer network 100 linking through a modem 170 a server 150 to every vending machine 180 and to the administrator computers 160 which are installed as required by the administrator. The management system comprises a database located in the memory of the server 150, administration software and communication software and also, vending machines 180 equipped with computer systems 140 comprising in their memory tables the copy of their inventory, as shown in FIG. 3.

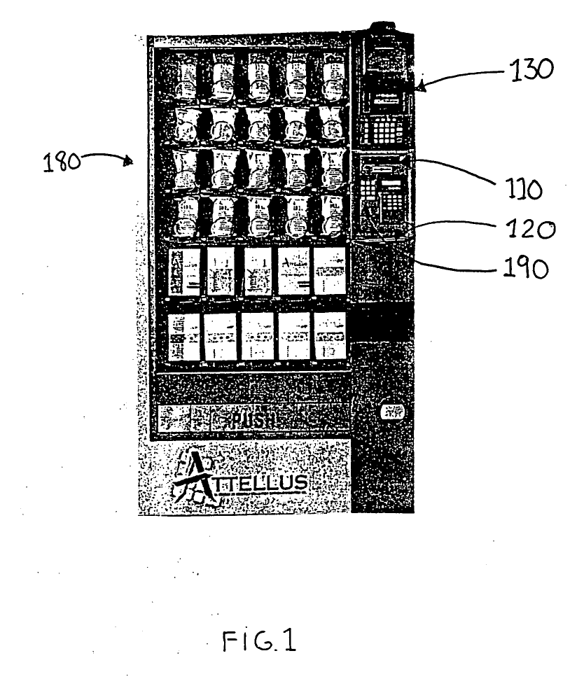

FIGS. 1, 3 and 9 show an embodiment of a vending machine 180 and of its computer system 140 which offers a variety of products with simple and interactive operating methods sending messages to the users, to the technicians and to the administrators of the vending machine 180.

When the vending machine 180 operates, it displays on the screen 110 a message requiring the entry of a user code. This user code is entered by typing on the keyboard 190 which is linked to the computer system 140 of the vending machine 140 via a connection 146. The numbers and/or letters corresponding to the code and each entered number/letter can be displayed on the screen 110 because of the connection 143 to the computer system 140. This code makes it possible to know if the user is authorized to use the vending machine 180. After the user has entered his code, the vending machine's 180 micro-controller 144 verifies the correspondence between the entered code and a code which can be found in the memory table 141 of the computer system 140 which contains all the valid codes. If the code is invalid, the micro-controller 144 resets and goes back to its starting menu. If the code is accepted, the micro-controller 144 goes to a second menu requiring the entry of a selection.

During that stage, the vending machine's 180 micro-controller 144 displays to the screen 110 a message asking the user to enter one or many selections. The selections correspond to a compartment number or to a reading of a bar code. The bar codes are used to allow the selection of products which cannot be physically located in the vending machine 180. They are consequently called virtual compartments. The way to enter the selections is by using the keyboard 190 for selecting one of the vending machine's 180 compartments and by using the optical pen 120 for the reading of bar codes on external products.

When the selections are entered, the micro-controller 144 of the vending machine 180 verifies in a memory table 142 containing all the acceptable compartment numbers if the selected compartment is valid. If the entered selection is invalid, the micro-controller 144 displays on the screen 110 an invalid selection message and the micro-controller 144 goes back to the menu requiring the entry of a selection of a product. If the selection is valid, the micro-controller 144 verifies in a memory table 142 containing the inventory of the vending machine if the selected compartment is not empty. If the compartment is empty, the micro-controller 144 displays on the screen 110 stating the empty compartment condition. If the compartment is not empty, the micro-controller 144 keeps in memory the entered selection and goes back to the menu asking another selection to the user or the end of product selection.

The way to make a selection of a product offered in a virtual compartment requires the choice of that option in the selection menu, then the micro-controller 144 displays the message which preferably asks for a code bar reading on the screen 110. This information could also be keyed in by the user. When the message appears, the user must take the optical pen 120 and scan the desired bar code. When reading a bar code, the pen 120 transmits the number associated to the bar code via a connection 148 to the micro-controller 144 of the vending machine 180, then the micro-controller 144 verifies in a memory table 142 containing all the possible virtual compartment numbers, if the read bar code is valid. If the bar code does not correspond, the micro-controller 144 displays on the screen 110 an invalid compartment selection message and goes back to the menu asking to enter the selections. If the bar code is validated, the micro-controller 144 verifies in the memory table 142 of the inventory if the selected virtual compartment is not “empty”. If the compartment is “empty”, the micro-controller 144 displays on the screen 110 a message stating that the compartment is empty. If it is not empty, the vending machine's 180 micro-controller 144 keeps the selection in memory and goes back to the menu asking for the entry of other selections.

When the user has finished making selections, he must enter a character corresponding to the end of selections on the keyboard 190, which indicates to the micro-controller 144 that the product selection has ended and that it can go to the next menu which concerns billing.

In the billing menu, the first task that the vending machine's 180 micro-controller 144 performs is the calculation of the billing amount. To do that, the micro-controller 144 gets the cost of each selection made from its memory table 142. The total of the selections is calculated, and then the micro-controller 144 sends the amount for display. The micro-controller 144 then builds the request to send to the integrated payment module 130 via a connection 149 to the vending machine's 180 computer system 140. This request comprises many parameters. The most important parameters are each product's description, the cost of each product and the total amount of those products. Once the payment module 130 receives the request, it sends an acknowledgment of receipt back to the micro-controller 144, and the payment module 130 starts the transaction by asking the client to insert his credit or debit card and his personal identification number in the case of a transaction with a debit card. The payment module 130 communicates to a banking terminal via a modem 170 and waits for the transaction's approval. When the approval is received by the payment module 130, this one sends the approval back to the micro-controller 144. The date and hour of the transaction is part of the approval.

In the event of a cash payment, a banknote reader (not shown), integrated to the vending machine's 180 computer system 140 via a connection 155, allows the micro-controller 144 to manage the transaction by itself. When the given amount is equal to the required amount, the micro-controller 144 also issues an approval.

That information is kept in memory to later be able to add it to a memory table 142 comprising the sales data. When the approval is sent to the micro-controller 144, the payment module 130 sends the transaction to the printer which executes the printing because of the computer system's 140 printer connection 156. During printing, the receipt containing the relative information regarding the paid amount and the user's selected products can also be formatted, for instance, such that it can reference a prescription in the case where the user must acquire medical supplies and that the receipt has to be presented to his/her insurance. After printing, the micro-controller 144 goes to the next menu regarding the product ejections.

To eject a product, the computer system's 140 micro-controller 144 communicates with the vending machine's 180 motor controller 147. Once the product has been ejected, the motor controller 147 sends back to the micro-controller 144 the information stating that the product has been correctly ejected. The micro-controller 144 follows this step until all the selections are ejected.

When all the selected products are ejected, the micro-controller 144 goes to the inventory update menu. To perform its inventory update, the micro-controller 144 must find the available quantities of each product in a memory table 142 and then decrements the quantity of each selected product by the quantity that has been ejected. Once the update is finished, the micro-controller 144 verifies via its memory table 142 if the new updated quantities have reached their critical quantities which have been determined by the administrator beforehand. If one of the selections has reached its critical quantity, the micro-controller 144 indicates to its memory table 142 that an electronic message will have to be sent.

To perform the update of the sales table, the micro-controller 144 writes the actual sales data. This sales table can be found on the memory table 142 of the computer system 140. Each sale is detailed in this memory table 142 and comprises, among other things, the user code of the person who made the transaction, the identification of each compartment from which a sale was made, the time and date of the transaction and the batch and sequence numbers which were given by the payment module 130 at the time of the transaction.

The last step associated to the functioning of the vending machine 180 for a transaction involving a user concerns the sending of electronic messages by the computer system's 140 micro-controller 144 in the vending machine 180, in the case where after a sale, a compartment reaches its critical quantity which was determined by the administrator beforehand. This message contains the identification of the vending machine 180 which sends the message, the identification of the compartment which has reached its critical quantity level and the quantity still left in its inventory.

Once the message has been constructed, the micro-controller 144 initiates a modem or any other type of communication with the server 150 of the network 100. Once the connection is established the micro-controller 144 transmits the message to the server 150 and then ends the communication. Once the message has been sent, the micro-controller 144 goes to its main menu.

On top of offering an innovative operating system in the field of vending machines 180, this invention also uses management modules destined to the network 100 administrators, which offer a range of functionalities allowing, among other things, the remote management of vending machines 180 and of their inventory, and also of the server's 150 database via a modem 170. All the relevant information which identifies each vending machine 180, their compartments and their virtual compartments are kept in memory, saved on the server 150 of the network 100 after the initialization of each vending machine 180 and before they start their service.

The remote ejection mode allows an administrator to connect to a vending machine 180 in order to eject a product. The reasons requiring the use of a remote ejection feature comprise the need to release a product which is stuck or defective without having to go through the billing system or the need to provide products to the hospital or a health provider for its internal use, by remotely releasing the required products and bill the hospital or health provider for them afterwards.

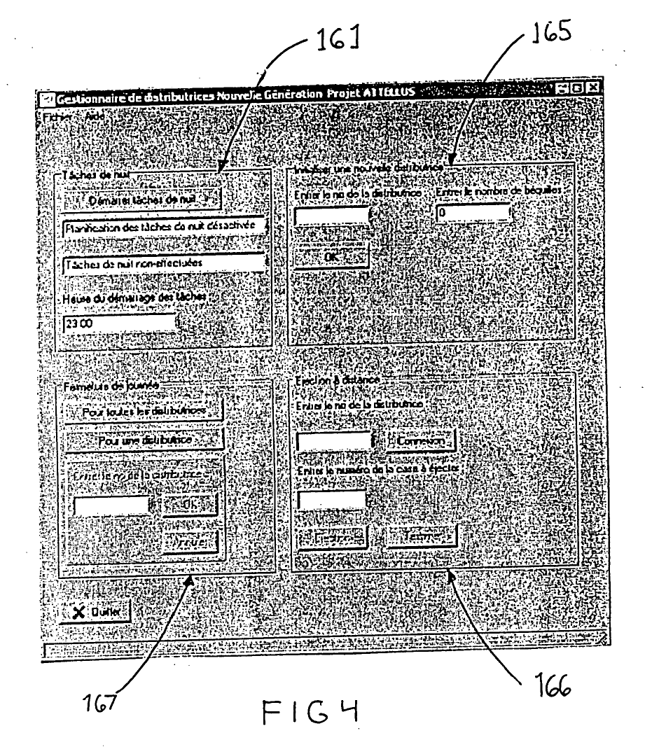

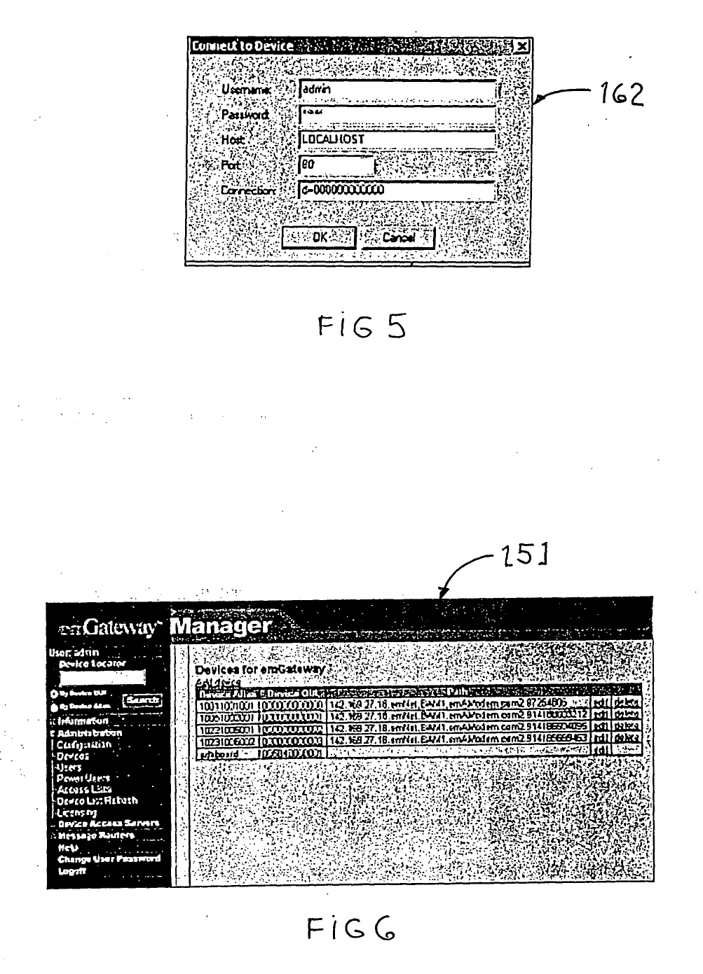

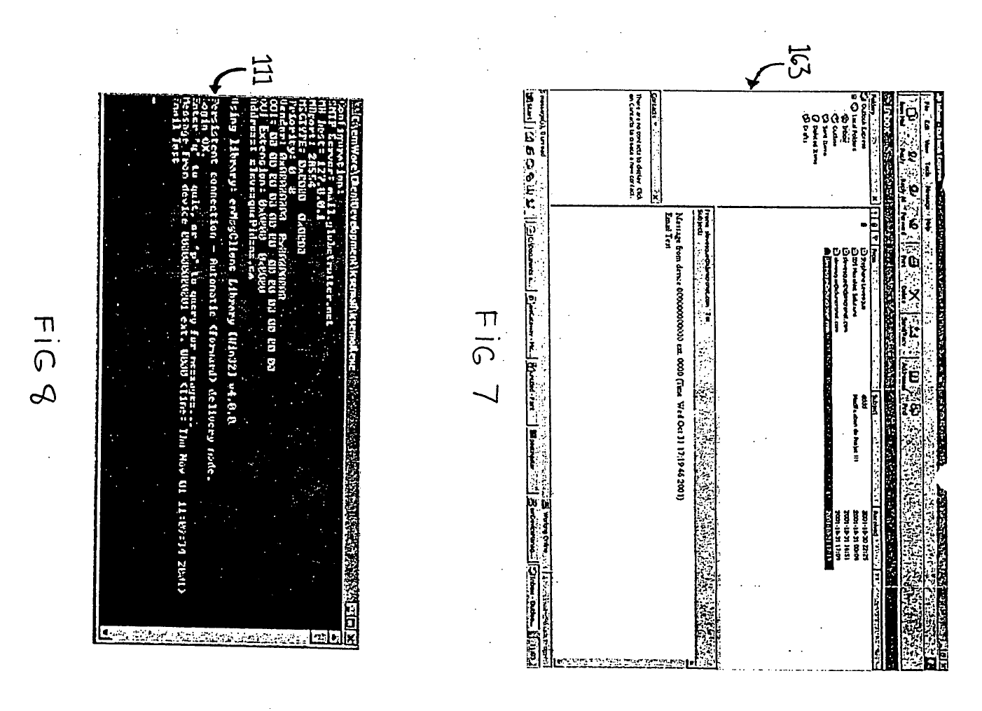

As shown in FIGS. 4, 5, 6 and 9, the remote ejection starts by accessing the administration software by its interface 162 which is installed on any computer linked to the network 100. The user asks for a connection with the help of the identification of the vending machine's 180 with which a communication is desired and via the ejection interface 166. The software then verifies the validity of the vending machine's 180 ID. If the ID is valid, the software initializes a communication with the vending machine 180 through the server 150. Once the connection is established, the administrator enters the compartment identification he/she wishes to activate and the software sends that information to the vending machine 180. The vending machine's 180 micro controller 144 sends to the motor controller 147 the command concerning the compartment ejection and then writes in the sales memory table 142 the required information. Once the sale has been recorded, the connection is shut. A camera (not shown), integrated to the vending machine's 180 computer system 140 via a connection 157 can also be used by the administrator, allowing him/her to judge by himself/herself the necessity to proceed with the remote ejection when a product is stuck in the vending machine 180. The image generated by the camera is therefore transmitted in one of the applications comprised on the computer terminal 160 of the administrator.

The remote sales retrieval feature allows updating the inventory of the vending machines 180 and of the server's 150 database of the network 100. First, the administrator must chose on the “closing day” interface 167 (manually operated) or on the automatic interface 161 if he/she wants to recuperate the sales data, of only one or of a group of vending machines 180. If the choice is for only one vending machine 180, the administrator must enter the identification of the vending machine he/she wants to reach. The administration software then initiates a connection with the vending machine 180 and then sends to its micro-controller 144 the command of sales data retrieval. The micro-controller 144 then sends all the sales data recorded in its memory table 142 from the last sales retrieval and then sends it to the administration software which then builds a file containing all the sales data. In that sales file, one line per sale comprises different information relative to the sales and it is used in order to add the sales in the server's 150 database. The administrator also has the choice to retrieve the sales data for a particular group of vending machines 180 by establishing a communication with each one of them, one at a time, the same way than for the way it is described for a single vending machine 180.

In a typical operation of this system, the remote fillings data retrieval sub-system then serves to identify, during the same established connection between the administrator's computer and the vending machine 180, if there was any filling made in any of the vending machines 180. When the software finishes retrieving the sales data, the software goes to the remote fillings data retrieval mode. In this mode, the administration software asks to the vending machine's 180 micro-controller 144 if there was any filling made since the last connection. If that is the case, the micro-controller 144 transfers to the administration software the data regarding the fillings. The transferred data is done for each compartment, including the quantities before and after the filling and the actual quantity. With the data, the administration software builds a file containing all the information which will be used by the database to update its inventory.

The remote compartment modification sub-system allows the modification of one or more compartments in the vending machine 180, thus permitting price modifications, the modification of the maximal quantity in a compartment, the modification of the critical quantity of a compartment or the modification of the product's description in a compartment. The way to modify a compartment consists in opening the server's 150 database and proceeding with the required changes via the modification interface 151 of a vending machine 180. Then, when the administrator proceeds with the sales data retrieval with the administration software, the software verifies if there were compartment modifications on the vending machine 180 to which it is connected. In this mode, the administration software transfers to the vending machine's 180 micro-controller 144 the changes to make to the compartments. If the modification to a compartment consists in replacing one product for another, which corresponds to a change of a product's description, the micro-controller 144 keeps this change in memory and at a filling, this modification will be carried out by specifying to the micro-controller 144 that the compartment's modification has occurred. If a compartment's modification does not necessitate a change of product, the modification is effective right away, without anybody's intervention.

This stage normally ends the succession of operations made by an administrator during the same connection with a vending machine 180, in order to allow him/her an accurate control of the inventory.

Other management functionalities allow this invention to offer a management system which was not previously available on the market. Indeed, the remote initialization sub-system of a vending machine 180 allows the transfer of a first or a new inventory to a vending machine 180. This sub-system is mostly used at the introduction stage of a new vending machine 180 by permitting to the administrator to automatically initialize a configuration with the requested products.

The way to proceed with a remote initialization of a vending machine 180 starts with the addition of the vending machine 180 in the database via the modification interface 151, and with the definition of each of the compartment's content for this vending machine 180 according to the needs of the hospital or other users. When the vending machine 180 is created in the database, the administrator opens the administration software and starts an initialization via the initialization interface 165.

To start an initialization, the administrator must enter the vending machine's 180 identification which he wants to initialize. Then, the software verifies with the database if the vending machine's 180 identification exists. If it is the case, the administration software starts a communication with the requested vending machine 180 and then transfers all the necessary data for its initialization. The transferred data includes all the inventory of the vending machine, comprising each product's description, their price, the maximal quantity of each of them and their critical quantity. The software also transfers all codes of the users having access to the vending machine. The software also initializes some tables and variables to ensure a good functioning of the vending machine 180. Then, when all the tables of the vending machine 180 are initialized, the administration software ends its connection with the vending machine which is now ready to be used.

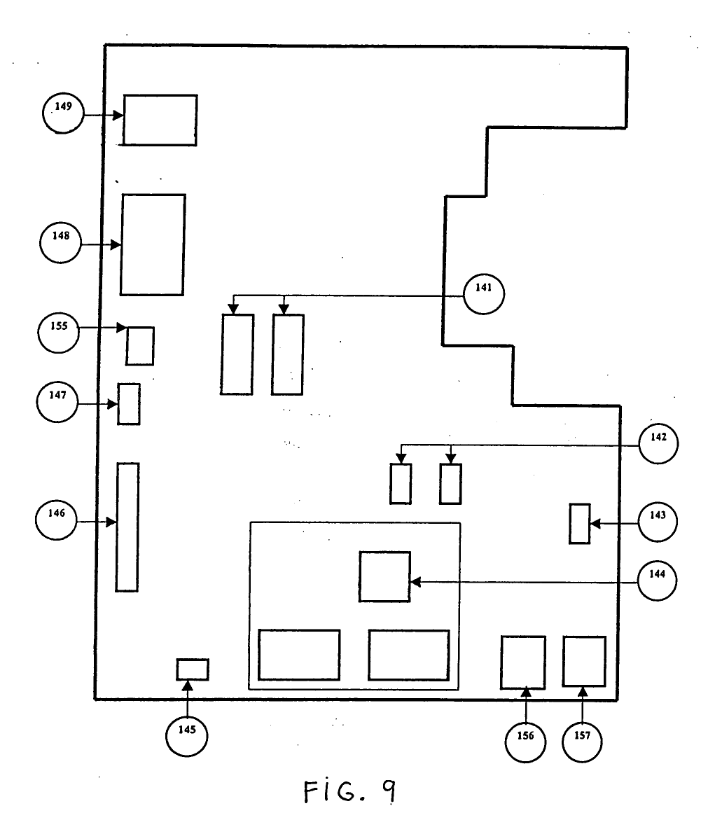

It is also possible to make a filling of a vending machine 180 with the help of an optical reader 120 and bar codes. Each compartment of the vending machine 180 has a corresponding bar code. Other bar codes are also available for other options. When a filling has to be made, the first step consists in opening the vending machine's 180 door. At that time, the micro-controller of the vending machine 180 goes to a filling mode via a switch door connector 145 (FIG. 9) and send a message to the vending machine's 180 screen 110 asking the technician if he/she wants to fill or repair the vending machine 180. If it is a repair, the technician must read the reparation bar code, proceed with the necessary repairs and close the door. If it is a filling, the filling bar code must be read with the optical reader 120.

After reading the bar code allowing the filling, the micro-controller 144 assumes that everything is full in the vending machine 180 as a default value. If during the filling, some of the compartments are not to their maximal quantity, the person doing the filling procedure must read the bar codes of each compartment to adjust the exact quantity. When reading a bar code corresponding to a compartment, the micro-controller 144 adjusts to the new quantity and displays it on the screen 120. When all the compartment's quantities are appropriate, the person has the choice of ending the filling procedure or reading the bar code which permits him/her to change products in order to proceed with the compartment's modification.

When there is a previously introduced change of products in the database by the system administrator, the vending machine 180 is made aware of this modification via the administration software. When reading the bar code allowing the modification, the micro-controller 144 asks in which compartment he/she desires to make the modification. At that time the user must read the bar codes corresponding to the number of the compartment to change. If the compartment number is valid, the computer system's 140 micro-controller 144 of the vending machine 180 proceeds with the change in its memory tables 142. Then, the technician has the choice of continuing with or ending the changes. After the reading of the ending bar code, the micro-controller 144 indicates that the user must close the door to end the filling. When the door is closed, the vending machine 180 goes back to its normal mode, waiting for a transaction.

On each vending machine 180, the administrator has the possibility to add virtual compartments. The virtual compartments correspond to compartment of a vending machine 180, but they are however located outside of the vending machine 180. The virtual compartments offer the possibility to sell products which cannot be located inside the vending machine. Also, they allow at the same time to increase and to control more strictly the inventory of a vending machine 180. The functioning of the virtual compartments preferably works with bar codes and an optical reader 120. Each vending machine 180 has an optical reader 120 for bar code readings. When a vending machine 180 has virtual compartments, a corresponding bar code is assigned to each virtual compartment. After reading that bar code, the micro-controller 144 gathers all the necessary information regarding this product in its memory table 142 to get the data concerning its inventory.

All those functionalities in this invention regarding the operating and management system are made possible via a bi-directional communication mode between the vending machines 180 and the server 150. The communication protocol is carried out via a modem 170 or other known means. Therefore, with the introduction of this communication means, it is possible to develop applications for personal computers, allowing to perform various remote operations on a vending machine 180.

This technology also allows the sending of electronic messages via a communication software. At the installation of the server 150, a message database is created and comprises the messages that the vending machines 180 send and can decipher. With this database, a communication software installed on the vending machine's 180 computer system 140 and on the administrator computer 160 can therefore look for new messages received in this database and also send some to specific addressees via electronic mail. As illustrated in FIGS. 8 and 9, the administrator's mail interface 163 and the one of the vending machine 111 allow the sending of messages between the various interveners inside the network 100. Therefore, by developing the vending machine's 180 communication software, one can specify various factors for which the result could be the sending of an electronic message. For instance, if a sale has been made and the critical quantity has been achieved, the vending machine 180 then initiates a communication with the server 150, transmits the message to the server 150 which then puts this message in a database, the communication software gets the message and transfers it to the requested addressees.

Although a preferred embodiment of the invention has been described herein, it should be apparent to those skilled in the art that variations and modifications are possible without departing from the spirit of this invention. For example, the described interface uses a keyboard. Other modes of data entry or selection like a mouse, a tactile screen or vocal commands could be used without changing the invention.

1. A system for distributing articles comprising:
a) a vending machine, adapted to distribute said articles and equipped with a computer system comprising a micro-controller and memory tables, and a payment module for credit and debit cards;
b) a server comprising a source database which consists in data concerning all the articles distributed by said vending machine and data relative to the authorizations of different users, administrators and technicians who use said vending machine or the server;
c) management software;
d) communication means linking the vending machine to the server;
e) a computer terminal linked to the server, to the management software and to the communication means;
wherein said management software links said server, said vending machine, said computer terminal and said communication means in a network which allows remote control operations on said database with the help of said computer terminal.

2. A system as claimed in claim 1, wherein a plurality of vending machines located in one or more locations are linked in a network and are remotely accessible by the computer terminal with the help of said communication means.

3. A system as claimed in claim 1, wherein said vending machine is adapted to distribute articles which are located outside said vending machine.

4. A system as claimed in claim 3, wherein said vending machine comprises an optical bar code reader.

5. A system as claimed in claim 1, wherein a plurality of computer terminals located in one or a plurality of locations are linked in a network and possess the capacity to remotely control one or a plurality of vending machines with the help of said communication means.

6. A system as claimed in claim 1, comprising control means for the remote ejection of articles from said vending machine.

7. A system as claimed in claim 6, wherein the vending machine comprises a plurality of compartments into which the articles are located and wherein said ejection control means comprise means for transmitting an ejection command from said computer terminal.

8. A system as claimed in claim 1, comprising means for the remote sales data retrieval relative to the use of said vending machine.

9. A system as claimed in claim 8, wherein said sales data retrieval means comprises means for transmitting a sales data to said server.

10. A system as claimed in claim 1, comprising means for the retrieval of article filling data for said vending machine.

11. A system as claimed in claim 10, wherein said filling data retrieval means comprises means for transmitting a data retrieval command.

12. A system as claimed in claim 11, comprising means for generating an inventory file per vending machine.

13. A system as claimed in claim 1, comprising means for the remote compartment modification, achieved from said computer terminal, via said network and with the help of said communication means.

14. A computer management system as claimed in claim 13, wherein said remote compartment modification means comprise means for transmitting a modification command to the articles' distribution parameters and the information relative to the different articles offered inside of the compartments from said computer terminal.

15. A system as claimed in claim 1, comprising means for the remote initialization of said vending machine, achieved from said computer terminal, via said network and with the help of said communication means.

16. A system as claimed in claim 15, wherein said remote initialization comprise means to transmit an inventory transmission command to said vending machine from said computer terminal.

17. A system for distributing articles comprising:
a) a vending machine, adapted to distribute articles and equipped with a computer system comprising a micro-controller and memory tables and a payment module for credit and debit cards;
b) a server comprising a source database which consists in data concerning all the articles to be distributed by said vending machine, information relative to the operation of said vending machine and the data relative to the authorizations of different users, administrators and technicians which use said vending machine or the server;
c) a management software;
d) a computer terminal linked to the server, to the management software and to the communication means;
e) communication means linking the vending machine to the server;
wherein said management software links said server, said vending machine, said computer terminal and said communication means in a network which allows the use of virtual compartments associated with articles located outside of said vending machine.

18. A system as claimed in claim 17, wherein said user reads a bar code identification of the articles to be distributed from said virtual compartment.

19. A system as claimed in claim 18, wherein the computer system of said vending machine comprises article availability verification means.

20. A system for distributing articles comprising:
a) a vending machine, adapted to distribute articles and equipped with a computer system comprising a micro-controller and memory tables and a payment module for credit and debit cards;
b) a server comprising a source database which consists in data concerning all the articles to be distributed by said vending machines, information relative to the operation of said vending machine and the data relative to the authorizations of different users, administrators and technicians which use said vending machine or the server;
c) a management software;
d) a computer terminal linked to the server and to the management software;
e) communication means linking the vending machine to the server;
f) article selection means;
g) payment means;
wherein said management software links said server, said vending machine, said computer terminal and said communication means in a network.

21. A method of distributing articles using a system, as claimed in claim 20, comprising the following step:
a) the entry of said user's identification;
b) the validation of the identification by said computer system's micro-controller of said vending machine;
c) the entry of the selection numbers;
d) verification in the micro-controller's memory tables of the selected articles' availability;
e) search for all the selected articles' prices in the memory tables of said computer system;
f) calculation of the total cost by said computer system;
g) display of the price on the screen of said vending machine;
h) invitation to said user to select and initiate the payment mode;
i) the acquisition of data by said payment module;
j) connection and transmission by modem of the banking data;
k) reception and acquisition of banking system's data confirming the sale;
l) printing of a sale receipt destined to the user which can be formatted and including the information relative to the distribution;
m) initiation of the ejection mechanism of said vending machine or of the distribution confirmation in the case of a virtual article.

22. A system, as claimed in claim 20, wherein many selections are possible for the same sale.

23. A system for a vending machine comprising:
a) a vending machine, adapted to distribute articles and equipped with a computer system comprising a micro-controller and memory tables and a payment module for credit and debit cards;
b) a server comprising a source database which consists in data concerning all the articles to be distributed by said vending machine, the information relative to the recording of said vending machine and the data relative to the authorizations of different users, administrators and technicians which use said vending machine or the server;
c) a management software;
d) a computer terminal linked to the server and to the management software;
e) communication means linking the vending machine to the server;
wherein said management software links said server, said vending machine, said computer terminal and said communication means in a network which offers a bidirectional communication functionality allowing the sending of messages.

24. A method of distributing articles using a system, as claimed in claim 23, wherein said bi-directional communication, comprising a list of messages contained within said server's database, is initiated when one of the configuration condition of the management system requiring the sending of a message is achieved, and with the server's connection steps, the sending of the message to the server and for the retrieval of the messages by the addressee.

25. A method of distributing articles using a system as claimed in claim 6, comprising the following steps:
a) connection to said network with the help of said communication means;
b) identification of said administrator;
c) identification of said vending machine;
d) identification of the number of the compartment from which an article is to be ejected;
e) sending of a ejection command to said vending machine;
f) transmission of the command by a micro-controller in the vending machine to an ejection mechanism connected to said compartment;
g) ejection of the article.

26. A method, as claimed in claim 25, further comprising a filling step of the vending machine's empty compartments, updating the computer system's database of said vending machine with the recording of the filling data and the generation of the filling file.

27. A method, as claimed in claim 26, wherein the filling and the generation of said filling file is accomplished with the following step which are performed by the technician during the filling of said vending machine:
a) identification of said technician;
b) opening of said vending machine;
c) selection of the filing bar code;
d) reading of the bar code for each empty compartment to fill and followed by the filling;
e) warning with the sending of a message by said vending machine to the technician in the case of article modifications previously initiated by message from the computer terminal;
f) article modifications if necessary;
g) memory table update of said computer system;
h) closing of the door.

28. A system as claimed in claim 1, wherein said computer system's memory table of said vending machine comprises a copy of its own inventory which is independent from said server.

29. A method of distributing articles using a system as claimed in claim 9 comprising the following steps:
a) connection to said network with the help of the communication means;
b) identification of said administrator;
c) identification of said vending machine;
d) sending of a sales data retrieval command to said vending machine;
e) initiation of the compilation of the sales data retrieval of the articles by said micro-controller of said vending machine;
f) sending of the sales data of the articles since last command;
g) creation of a sales file on said server.

30. A method of distributing articles using a system as claimed in claim 11 comprising the following steps:
a) connection to said network with the help of the communication means;
b) identification of said administrator;
c) sending of a filling data retrieval command to said server;
d) search of the existence of said filling files inside said server from this vending machine;
e) initiation of a database update with the help of said filling files originating from said vending machine and received since the last command.

31. A method of distributing articles using a system as claimed in claim 14 comprising the following steps:
a) connection to said network with the help of the communication means;
b) identification of said administrator;
c) access to said database;
d) identification of said vending machine;
e) identification of said compartment to be modified;
f) modifications to the database regarding the distribution parameters and/or a change of article;
g) sending of a compartment modification command to said vending machine;
h) automatic modification of the computer system's memory table of said vending machine if the modification relates to a distribution parameter;
i) modification of the computer system's memory table delayed to the filling of said vending machine if the modification relates to the article to be modified.

32. A method of distributing articles using a system as claimed in claim 16 comprising the following steps:
a) connection to said network with the help of the communication means;
b) identification of said administrator;
c) access to said database;
d) identification or creation of said identification profile of said vending machine;
e) modification or transfer to said database of an inventory profile from an already existing vending machine to said vending machine to be initialized;
f) connection to said vending machine;
g) sending of a command starting the initialization to the computer system of said vending machine.
